(19) United States
(12) Patent Application Publication
(10) Pub. No.: US 2011/0047011 A1
(43) Pub. Date: Feb. 24, 2011

(54) INCENTIVES TO OPTIMIZE THE PERFORMANCE OF FEMTO CELL GROUPS

(75) Inventor: Thomas M. Tirpak, Glenview, IL (US)

Correspondence Address: MOTOROLA MOBILITY, INC, 600 NORTH US HIGHWAY 45, W2-55BB, LIBERTYVILLE, IL, 60048-5343, US

(73) Assignee: MOTOROLA, INC., Schaumburg, IL (US)

(21) Appl. No.: 12/546,221

(22) Filed: Aug. 24, 2009

(51) Int. Cl. G06Q 30/00; G06Q 50/00; H04M 3/42

(52) U.S. Cl. 705/14.1; 455/414.1

(57) ABSTRACT

A method of incentivizing an operator of femto cell infrastructure to efficiently utilize the femto cell infrastructure. The method can include establishing, for an end user device, telecommunication network presence on a femto cell. The femto cell can be a geographic region serviced by the femto cell infrastructure, which establishes wireless communication links within the femto cell. Further, the femto cell can be smaller than a macro cell supported by infrastructure operated by a communication services provider. At least one parameter measured within the femto cell can be received. Based on the measured parameter, a determination can be made as to whether to award at least one incentive to the operator of the femto cell, and the incentive can be awarded to the operator.

### BACKGROUND OF THE INVENTION

1. Field of the Invention

The present invention generally relates to cellular communications and, more particularly, to optimizing the performance of femto cell groups.

2. Background of the Invention

The convergence of wireless communication and mobile computing devices continues to spur demand for wireless broadband communication services. As the demand grows, so too must the network infrastructure needed to support wireless communications. Capital expenses (e.g., cellular communication towers, base transceiver stations, base station controllers, etc.) and operating expenses (e.g., energy costs, site leases, ongoing maintenance, etc.) for network infrastructure typically represents a large portion of a wireless communication service provider's operating budget. Accordingly, wireless communication service providers continue to search for new ways to expand network capacity in a cost effective manner.

One concept currently being investigated is the use of femto cells within a cellular communication system. Much like a conventional cell that is commonly known in the art, a femto cell is a geographic region in which cellular communication services are provided, but the size of the femto cell is smaller than a conventional cell. For example, whereas a conventional cell may include many square miles of coverage area, a femto cell may cover a particular neighborhood, a portion of a neighborhood, a particular building, or a portion of a building.

In some marketing concepts being investigated, it is anticipated that femto cell infrastructure (e.g., femto transceiver stations) will be owned by end users or end user groups. For example, a condominium association may purchase and install its own femto transceiver station to service condominium occupants in a particular neighborhood. Individual homeowners and businesses also may wish to purchase and install their own femto transceiver stations as well.

Although bandwidth can be allocated to each femto transceiver station to support backhaul communications, which is commonly referred to as an in-band backhaul, in other scenarios backhaul communications can be communicated over wired broadband Internet links. For instance, backhaul communications can be implemented using digital subscriber line (DSL) services, cable Internet communication services, or the like. The use of wired broadband Internet links to support backhaul communications generally is preferred over the use of in-band backhaul communications because the use of a wired backhaul does not consume valuable RF bandwidth, thereby minimizing the burden on the wireless communication infrastructure. Indeed, prospective owners of femto transceiver stations may bear the burden of providing Internet connections.

### SUMMARY OF THE INVENTION

The present invention relates to a method of incentivizing an operator of femto cell infrastructure to efficiently utilize the femto cell infrastructure. The method can include establishing, for an end user device, telecommunication network presence on a femto cell. The femto cell can be a geographic region serviced by the femto cell infrastructure, which establishes wireless communication links within the femto cell. Further, the femto cell can be smaller than a macro cell supported by infrastructure operated by a communication services provider. At least one parameter measured within the femto cell can be received. Based on the measured parameter, a determination can be made as to whether to award at least one incentive to the operator of the femto cell, and the incentive can be awarded to the operator.

Yet another embodiment of the present invention can include a computer program product including a computer-usable medium having computer-usable program code that, when executed, causes a machine to perform the various steps and/or functions described herein.

### BRIEF DESCRIPTION OF THE DRAWINGS

Preferred embodiments of the present invention will be described below in more detail, with reference to the accompanying drawings, in which:

FIG. 1 depicts a communication system that is useful for understanding the present invention; and

FIG. 2 depicts a flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

Arrangements described herein relate to a method and a system for incentivizing users and/or owners of femto cell infrastructure, for instance femto transceiver stations, to efficiently utilize such infrastructure. For example, owners of femto transceiver stations can be enticed to implement the femto transceiver stations in a manner that minimizes communication traffic on macro cell infrastructure, and users of femto transceiver stations can be enticed to efficiently utilize the femto transceiver stations. An owner of a femto transceiver station also can be a user of the femto transceiver station, though this need not be the case. Hereinafter, owners and users of femto transceiver stations collectively will be referred to as “operators.”

As used herein, a macro cell is a geographic region in which wireless communications are supported by infrastructure, such as a base transceiver station, operated by a communication services provider. As used herein, a femto cell is a geographic region serviced by a femto transceiver station. In general, a femto cell will comprise a smaller geographic region than a macro cell. Moreover, a femto cell may be wholly or partially located within a macro cell.

As used herein, a femto transceiver station is a transceiver station that supports a telecommunications protocol, but which may be owned by an entity other than a telecommunications service provider (e.g., the femto cell is owned by an end user or group of end users), and which is used to provide to end user devices wireless communication access to telecommunications infrastructure. Examples of telecommunication protocols supported by a femto transceiver station include, but are not limited to, TDMA, CDMA, WCDMA, GSM, UMTS, GPRS, 3G, 4G, UMB, OFDM, LTE or the like. Even though a femto transceiver station supports telecommunication protocols, a femto transceiver station can provide wireless broadband communications, for instance voice over Internet protocol (VoIP) and data communications. Moreover, a femto transceiver station can include a backhaul controller, a base site (e.g., an enhanced Node B (eNB) base site), etc.

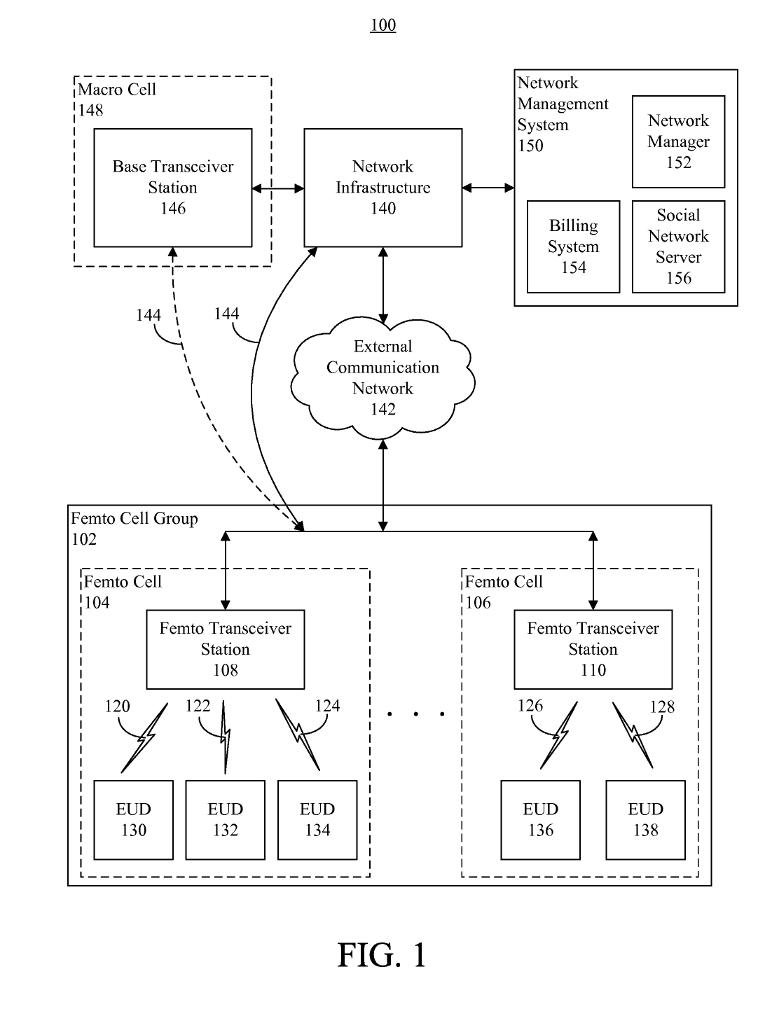

FIG. 1 depicts a communication system 100 that is useful for understanding the present invention. The communication system can include a femto cell group 102 comprising one or more femto cells 104, 106. Femto cell infrastructure can be provided to establish wireless communication links 120, 122, 124, 126, 128 with one or more end user devices (EUDs) 130, 132, 134, 136, 138, and communicatively link the EUDs 130-138 to network infrastructure 140. The EUDs 130-138 can be mobile telephones, portable radios, personal digital assistants, or any other wireless end user devices that communicate with the femto transceiver stations 108, 110 using a telecommunications protocol.

The femto cell infrastructure for each femto cell 104, 106 can include, for example, a femto transceiver station 108, 110. Thus, each femto transceiver station 108, 110 can constitute a respective node of the femto cell group 102. Each femto transceiver station 108, 110 can include at least one transceiver to support the wireless communication links 120-128. The femto cell infrastructure also may include other devices, for instance computers, user input devices, display devices, or any other equipment that may be utilized to support communications in a femto cell.

The femto cell group 102 can be dynamically configurable. For instance, femto cells 104, 106 which have similar characteristics can be selected as members of the femto cell group 102. In illustration, femto cells which are geographically contiguous can be selected as members of the femto cell group 102. If small femto cell groups are desired, the geographically contiguous femto cell group 102 can be limited to femto cells 104, 106 within a certain housing development, or a certain portion of a village, town or city. Femto cell groups 102 also can be limited to specific types of housing. For example, the femto cell group 102 can be limited to apartments within a geographic region, condominiums within a geographic region, town homes within a geographic region, single family homes within a geographic region, and so on. Moreover, the femto cell group 102 can be limited to a particular business, a particular type of business within a geographic region, etc.

In some instances, a femto transceiver station 108, 110 need only provide communications coverage within a portion of a building or other structure, in which case the femto transceiver station may be referred to as a pico transceiver station. Nonetheless, as used herein, a pico transceiver station is considered to be another embodiment of a femto transceiver station, and is considered to be within the scope of the present invention.

The femto cells 104, 106 to be included in the femto cell group 102 can be dynamically selected based on parameters measured in the individual femto cells 104, 106 (e.g., measured by the femto transceiver stations 108, 110 or other femto cell infrastructure), parameters measured within a plurality of femto cells 104, 106, and/or parameters measured elsewhere within the communication system 100. Hence, a femto cell 104, 106, and a femto transceiver station 108, 110, can be disassociated with a particular femto cell group 102 and re-associated with another femto cell group when the parameters indicate it is desirable to do so. In another arrangement, one or more of the femto cells 104, 106 and the associated femto transceiver stations 108, 110 can be statically assigned to the femto cell group 102.

Examples of parameters that can be measured include, but are not limited to, quality of service, number of dropped calls, signal strength, latency, data rate, etc., related to the communication links 120-128 for the wireless communication links 120-128 between the femto transceiver stations 108, 110 and the EUDs 130-138. Any other parameters pertaining to the femto cells 104, 106 that are measurable can be measured and the invention is not limited in this regard.

The femto transceiver stations 108, 110 can communicatively link the EUDs 130-138 to the network infrastructure 140 using one or more suitable backhauls. As used herein, the term “backhaul” means a communication link over which data is communicated between a centralized network node, such as a communication node of the network infrastructure 140, and one or more distributed sites, such as the femto transceiver stations 108, 110.

In one arrangement, the backhaul can be established using an external communication network 142, such as the Internet. In illustration, the femto transceiver stations 108, 110 can establish one or more backhauls over a digital subscriber line (DSL), a cable Internet link, a fiber optic link, or any other suitable Internet connection. In another arrangement, the backhaul can be established over a communication link 144 that does not depend on the external communication network 142.

Regardless of whether the communication network 142 or the communication link 144 is used for backhaul communications, the backhaul can be implemented using wired and/or wireless communications. In this regard, a fiber optic link may be considered a wired communication link.

If a backhaul is implemented using wired communications, the femto transceiver stations 108, 110 each can comprise a backhaul controller (or any other suitable network adapter) that is suitably configured to implement wired communications. In an arrangement in which the backhaul is implemented using wireless communications, each of the femto transceiver stations 108, 110 can include a transceiver that is suitably configured to support wireless backhaul communications. Such transceivers can be the same transceivers used by the femto transceiver stations 108, 110 to communicate with the EUDs 130-138, or can be dedicated backhaul transceivers.

In one aspect of the inventive arrangements, the backhaul 144 can be established with a base transceiver station 146, though this need not be the case. The base transceiver station 146 may be tasked with providing wireless communication access within a macro cell 148, and the femto cells 104, 106 can be geographically located within the macro cell 148, though this is not required. For example, the femto cells 104, 106 can be located in another macro cell serviced by another base transceiver station, one or more of the femto cells 104, 106 may only be partially located within the macro cell 148, or the femto cells 104, 106 may be located in a geographic region in which a macro cell is not located.

The femto transceiver stations 108, 110 can handle one or more operations typically handled by a conventional wireless telecommunications base transceiver station. For example, the femto transceiver station 108 can coordinate with the femto transceiver station 110 or a base transceiver station 146 to handoff communication sessions established by the EUDs 130-138 while the EUDs 130-138 are roaming. Protocols for implementing a handoff of a EUD 130-138 from one transceiver station to another are well known in the art of mobile communications.

In addition, the femto transceiver stations 108, 110 can implement suitable protocols which are used to establish network presence (e.g., telecommunication network presence or data communication network presence) for the end user devices 130-138 on the femto cells 104, 106, terminate communication sessions from the femto cells 104, 106, and the like. The femto transceiver stations 108, 110 also can measure local parameters that indicate network performance, and communicate such parameters over the backhaul 144 to a suitable system for processing, as will be described.

In one aspect of the inventive arrangements, the femto cell group 102 can be a closed cell group that is limited to use by authorized EUDs 130-138. For example, each EUD can be assigned a device address (e.g., a MAC address, a telephone number, an IP address, etc.), and the device addresses can be associated with the femto cell group. This association can be established individually on the femto transceiver stations 108, 110, or can be established elsewhere within the communication system 100, for instance at the base transceiver station 146 or at another suitable component of the network infrastructure 140, for instance a base station controller, a network management system 150 (which will be described herein), etc.

If a EUD 130 roams outside the service area covered by the femto cell group 102, the EUD 130 can handoff to the base transceiver station 146 or another suitable node of the communication system 100. Similarly, if the EUD 130 roams into the femto cell group coverage area, the EUD 130 can handoff to a femto transceiver station 108, 110 in the femto cell group 102, thereby freeing up bandwidth on the network node from which the EUD 130 is handing off.

Moreover, the femto transceiver stations 108, 110 can be configured as preferred transceiver stations for the EUDs 130-138. For example, even though a EUD 130 may be experiencing a better quality of service from the base transceiver station 146 than the quality of service presently available from one or more of the femto transceiver stations 108, 110, but the quality of service available from at least one of the femto transceiver stations 108, 110 is adequate for the desired communication purposes, the EUD 130 can be directed to communicate via that femto transceiver station 108, 110. For example, once the quality of service between the femto transceiver station 108 and the EUD 130 is adequate, a handoff from the base transceiver station to the femto transceiver station 108 can be initiated. The handoff can be initiated by the EUD 130, the base transceiver station 146, the network management system 150, or any other suitable network infrastructure 140.

In another aspect of the inventive arrangements, the femto cell group 102 can be an open cell group that is configured to allow unknown EUDs 130-138 to use one or more of the femto transceiver stations 108, 110. As used herein, an unknown EUD is a EUD that is not previously associated with the femto cell group 102 prior to establishing network presence on the femto cell group 102.

The network management system 150 can be a component of the communication system 100. The network management system 150 can include a network manager 152, a billing system 154 and a social network server 156. The network manager 152 can be implemented as a centralized self-organizing network element. For example, the network manager 152 can receive parameters measured by the femto transceiver stations 108, 110 and/or any other components of the communication system 100. Further, the network manager 152 can implement data mining to analyze parameters from different perspectives and summarize the parameters into information that is useful for making and executing network management decisions.

Based on the parameters and/or information derived from the parameters, the network manager 152 can dynamically assign the femto cells 104, 106 (e.g., the femto transceiver stations 108, 110) to one or more femto cell groups, for instance the femto cell group 102. By way of example, a particular femto cell 104 can be associated with a femto cell group 102. Based on the measured parameters, however, the network manager 152 can disassociate the femto cell 104 from the femto cell group 102, and assign the femto cell 104 to another femto cell group. In another arrangement, the association of the femto cell 104 with the femto cell group 102 can remain, and another association can be created which also assigns the femto cell 104 to another femto group. In illustration, the femto cell 104 may be assigned to another femto group if the femto cell 104 provides a threshold level of use by unknown users.

The network manager 152 also can evaluate the performance of various femto cell groups. For instance, the network manager 152 can determine a quality of service provided by the femto cell group 102, a rate of dropped calls on the femto cell group 102, available bandwidth on the femto cell group 102, and so on. The performance evaluation can be performed for various time frames. In illustration, the daytime and/or nighttime performance of the femto cell group 102 can be determined, the weekday and/or weekend performance can be determined, the performance for a particular day, week, month, quarter or year can be determined, and so on.

Based on the performance of an individual femto cell 104, the network manager 152 can award one or more incentives to the operator of the femto cell infrastructure within the femto cell 104 (e.g., an operator of the femto transceiver station 108). The operator may be an active participant in the femto cell group 102, or a passive operator who owns femto cell infrastructure, but does not participate in the femto cell's management. In another arrangement, incentives can be awarded to operators of femto cell infrastructure for a plurality of femto cells 104, 106 within a femto cell group 102. For example operators of the femto transceiver stations 108, 110 can be awarded incentives. By way of example, threshold performance levels can be established, and incentives can be awarded when the performance of an individual femto cell 104, or the performance of femto cell group 102, meets or exceeds the threshold performance levels. Any of a myriad of incentives can be provided.

Incentives also may be awarded for allowing the femto transceiver stations 108, 110 to be used by EUDs that are not part of the femto cell group. In other words, the incentives that are awarded can be based on the amount of use that is provided to EUDs that are not part of the femto cell group 102 (i.e., unknown EUDs). These incentives can be based on the duration of such use, the number of times the femto transceiver stations 108, 110 are used by unknown EUDs, or determined in any other suitable manner.

Incentives that are awarded can include, for instance, financial incentives such as discounts on bills (e.g., invoices), gift certificates, coupons, credits for services, and so on. Such financial incentives can correspond to services/products provided by a communication services provider, or to another entity with which the communication services provider has established a suitable financial incentive agreement. In the arrangements in which financial incentives are provided, the network manager 152 can interface with the billing system 154 to apply the incentives to the appropriate bills, generate gift certificates or coupons, etc.

In another arrangement, an incentive that may be awarded can include dynamically upgrading a femto cell service plan. For example, additional bandwidth can be provided (e.g., on the backhaul 144) to a femto transceiver station 108, 110 or to all femto transceiver stations 108, 110 in a femto cell group. Additional service features also can be awarded as incentives. For example, text messaging services can be provided at no cost or at reduced cost, or media content can be made available for download at no cost or at reduced cost. Furthermore, additional voice call minutes and/or an additional amount of text messaging can be provided at no cost or at reduced cost.

Other incentives that are awarded can include data backup services, location-based services, personal content management services, and so on. An awarded operator also may receive an enhanced set of access privileges, priority levels, user group memberships, and the like. For example, an operator can be awarded access, or upgraded access, to social network services provided by the social network server 156 and/or custom features of the social network server 156. In illustration, the operators can be provided a private forum in which to participate. The operators can use the forum to post information for review by other operators, to send private messages, to coordinate events, and so on. The operators also may be provided the opportunity to include friends and family in the private forum. The operators can be provided access to the private forum for a limited period, or can be provided continuous access while parameters measured for the femto cell group 102 indicate that the femto cell group continues to meet performance thresholds.

Contests and contest rules also can be established, and users who are using various femto cell groups can compete against one another to win incentives that are being offered. One example of such a contest can be one in which the femto cell group with the highest quality of service over a particular period is determined to be the winner, and incentives can be provided to each of the operators of the femto transceiver stations 108, 110 in the winning femto cell group 102. The contest rules can limit those femto cell groups that compete with one another to a particular geographic region, for instance to a neighborhood, a city, a county or a state, but the invention is not limited in this regard. Further, for the purposes of the context, various femto cell groups may be combined into teams. For instance, femto cell groups in one geographic area may be teamed to compete against femto cell groups in another geographic area.

In another example, an open contest can be hosted by a communication services provider to promote collaboration and reuse of strategies for best optimizing the use of femto cell groups. As a condition of the contest, femto cell groups can allow their contest submissions to be shared with other femto cell groups, such as the other femto cell groups participating in the contest.

The femto cell infrastructure can automatically collect and report operating data pertaining to the femto cell group, and periodically report the operating data to the network management system 150. The operating data may include control settings. Examples of the control settings include, but are not limited to, channel selections, frequency selections, admission control algorithms, interference mitigation algorithms, hand-off control algorithms, transmit power levels, relative prioritization of known and unknown users, location data source and adjustment method (e.g., GPS where available), and the like. Operating data also may include historical characteristics of the EUDs 130-138 accessing a femto transceiver station 108, 110 the types of communication sessions being established by the EUDs 130-138.

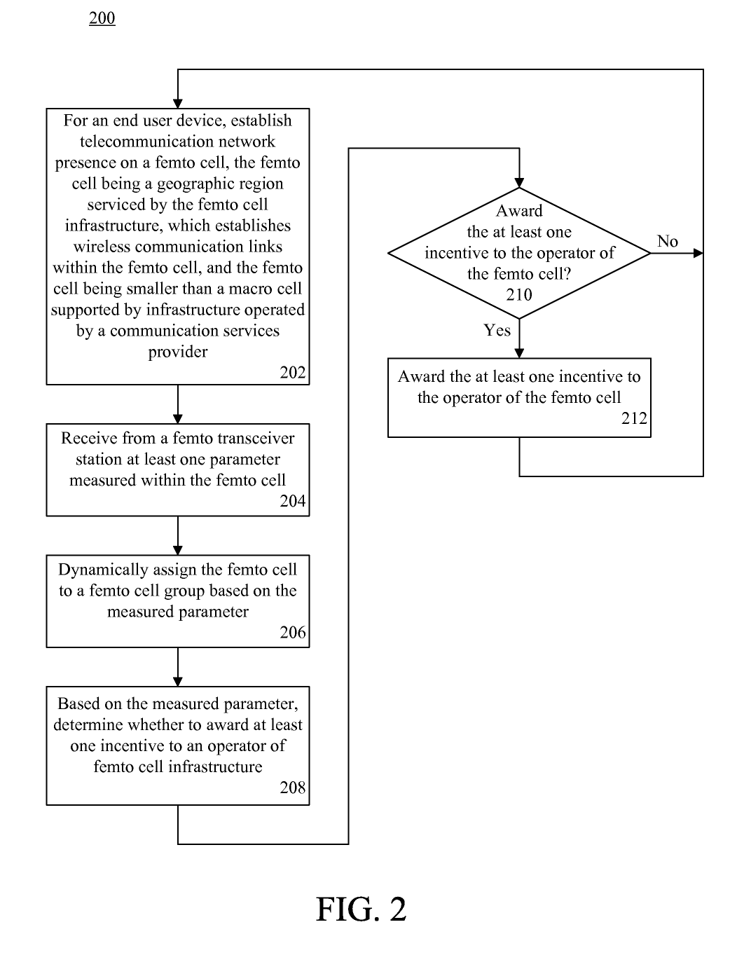

FIG. 2 depicts a flowchart that is useful for understanding a method 200 of incentivizing an operator of femto cell infrastructure to efficiently utilize the femto cell infrastructure. At step 202, telecommunication network presence on a femto cell can be established for an end user device. The femto cell can be a geographic region serviced by the femto cell infrastructure, which establishes wireless communication links within the femto cell. Further, the femto cell can be smaller than a macro cell supported by infrastructure operated by a communication services provider.

At step 204, at least one parameter measured within the femto cell can be received. The received parameter can be a quality of service parameter, a parameter that indicates a number of dropped calls, a parameter that indicates an amount of use provided to end user devices that are not part of a femto cell group with which the femto cell infrastructure is associated, or an operating parameter of the femto cell infrastructure. The present invention is not limited to these examples, however. Indeed, the received parameter can be any other parameter which may be processed to incentivize an operator of femto cell infrastructure to efficiently utilize the femto cell infrastructure.

At step 206, the femto cell can be dynamically assigned to a femto cell group based on the measured parameter. At step 208, based on the measured parameter, a determination can be made as to whether to award at least one incentive to an operator of femto cell infrastructure. The operator can be an owner of the femto cell infrastructure or a user of the femto cell infrastructure.

Referring to decision box 210, if a determination is made to award at least one incentive to the operator of the femto cell, at step 212 the incentive can be awarded to the operator of the femto cell. The incentive can be a financial incentive, access to a social networking service, or any other incentive that may provide motivation to operators of femto cell infrastructure to efficiently utilize the femto cell infrastructure.

The flowchart and block diagram in the figures illustrate the architecture, functionality, and operation of possible implementations of systems, methods and computer program products according to various embodiments of the present invention. In this regard, each block in the flowchart or block diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The present invention also can be embedded in a computer-usable medium, such as a computer program product or other data programs storage device, readable by a machine, tangibly embodying a program of instructions executable by the machine to perform methods and processes described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

Moreover, as used herein, ordinal terms (e.g. first, second, third, fourth, fifth, sixth, seventh, eighth, ninth, tenth, and so on) distinguish one message, signal, item, object, device, system, apparatus, step, process, or the like from another message, signal, item, object, device, system, apparatus, step, process, or the like. Thus, an ordinal term used herein need not indicate a specific position in an ordinal series. For example, a process identified as a “second process” may occur before a process identified as a “first process.” Further, one or more processes may occur between a first process and a second process.

This invention can be embodied in other forms without departing from the spirit or essential attributes thereof. Accordingly, reference should be made to the following claims, rather than to the foregoing specification, as indicating the scope of the invention.

What is claimed is:

1. A method of incentivizing an operator of femto cell infrastructure to efficiently utilize the femto cell infrastructure, comprising:
receiving at least one parameter measured within at least one femto cell, the femto cell being a geographic region serviced by the femto cell infrastructure, which establishes wireless communication links within the femto cell, and the femto cell being smaller than a macro cell supported by infrastructure operated by a communication services provider;
based on the measured parameter, determining whether to award at least one incentive to the operator of the femto cell; and
awarding to the operator of the femto cell infrastructure the at least one incentive.

2. The method of claim 1, wherein receiving at least one parameter measured within the femto cell comprises:
receiving a quality of service parameter.

3. The method of claim 1, wherein receiving at least one parameter measured within the femto cell comprises:
receiving a parameter that indicates a number of dropped calls.

4. The method of claim 1, wherein receiving at least one parameter measured within the femto cell comprises:
receiving a parameter that indicates an amount of use provided to end user devices that are not part of a femto cell group with which the femto cell infrastructure is associated.

5. The method of claim 1, wherein receiving at least one parameter measured within the femto cell comprises:
receiving at least one operating parameter of the femto cell infrastructure.

6. The method of claim 1, wherein awarding to the operator of the femto cell infrastructure at least one incentive comprises:
awarding at least one financial incentive to the operator of the femto cell infrastructure.

7. The method of claim 1, wherein awarding to the operator of the femto cell infrastructure at least one incentive comprises:
awarding to the operator of the femto cell infrastructure access to at least one social networking service.

8. The method of claim 1, wherein awarding to the operator of the femto cell infrastructure at least one incentive comprises:
awarding the incentive to at least one owner of the femto cell infrastructure.

9. The method of claim 1, wherein awarding to the operator of the femto cell infrastructure at least one incentive comprises:
awarding the incentive to at least one user of the femto cell infrastructure.

10. The method of claim 1, further comprising:
dynamically assigning the femto cell to at least one femto cell group.

11. The method of claim 8, wherein dynamically assigning the femto cell to the femto cell group comprises:
dynamically assigning the femto cell to the femto cell group based on the measured parameter.

12. A method of incentivizing operators of femto cell infrastructure to efficiently utilize the femto cell infrastructure, comprising:
for an end user device, establishing telecommunication network presence on a femto cell, the femto cell being a geographic region serviced by the femto cell infrastructure, which establishes wireless communication links within the femto cell, and the femto cell being smaller than a macro cell supported by infrastructure operated by a communication services provider;
receiving at least one parameter measured within the femto cell;
based on the measured parameter, determining whether to award at least one incentive to an operator of the femto cell infrastructure that establishes wireless communication links in the femto cell; and
awarding to the operator of the femto cell infrastructure at least one incentive.

13. A computer program product comprising:
a computer-usable medium comprising computer-usable program code that incentivizes an operator of femto cell infrastructure to efficiently utilize the femto cell infrastructure, the computer-usable medium comprising:
computer-usable program code that receives at least one parameter measured within at least one femto cell, the femto cell being a geographic region serviced by the femto cell infrastructure, which establishes wireless communication links within the femto cell, and the femto cell being smaller than a macro cell supported by infrastructure operated by a communication services provider;
computer-usable program code that, based on the measured parameter, determines whether to award at least one incentive to an operator of the femto cell infrastructure; and
computer-usable program code that awards at least one incentive to the operator of the femto cell infrastructure.

14. The computer program product of claim 13, wherein the computer-usable program code that receives at least one parameter measured within the femto cell comprises:
computer-usable program code that receives a quality of service parameter.

15. The computer program product of claim 13, wherein the computer-usable program code that receives at least one parameter measured within the femto cell comprises:
computer-usable program code that receives a parameter that indicates a number of dropped calls.

16. The computer program product of claim 13, wherein the computer-usable program code that receives at least one parameter measured within the femto cell comprises:
computer-usable program code that receives a parameter that indicates an amount of use provided to end user devices that are not part of a femto cell group with which the femto cell infrastructure is associated.

17. The computer program product of claim 13, wherein the computer-usable program code that receives at least one parameter measured within the femto cell comprises:
computer-usable program code that receives at least one operating parameter of the femto cell infrastructure.

18. The computer program product of claim 13, wherein the computer-usable program code awards to the operator of the femto cell infrastructure at least one incentive comprises:
computer-usable program code that awards at least one financial incentive to the operator of the femto cell infrastructure.

19. The computer program product of claim 13, wherein the computer-usable program code awards to the operator of the femto cell infrastructure at least one incentive comprises:
computer-usable program code that awards to the operator of the femto cell infrastructure access to at least one social networking service.

20. The computer program product of claim 13, the computer-usable medium further comprising:
computer-usable program code that dynamically assigns the femto cell to at least one femto cell group.
